(19) United States
(12) Patent Application Publication
(10) Pub. No.: US 2015/0345099 A1
(43) Pub. Date: Dec. 3, 2015

(54) Portable Removable Trailer Anchor System

(71) Applicant: Scott Eugene Griffiths, Midwest, WY (US)

(72) Inventor: Scott Eugene Griffiths, Midwest, WY (US)

(21) Appl. No.: 14/292,891

(22) Filed: May 31, 2014

(51) Int. Cl. E02D 5/80; B62D 63/06; B62D 63/08; E04H 15/62

(52) U.S. Cl. CPC E02D 5/80; E04H 15/62; B62D 63/062; B62D 63/08

(57) ABSTRACT

A portable removable trailer anchor system is presented. portable removable trailer anchor system is able to be transported to various and difficult geographical areas, placed on the surface and able to provide support for vertically elevated objects. The portable removable trailer anchor system can be hauled via the trailer portion and the anchor weight portion can be removed from the trailer portion. Both the trailer anchor and the removable anchor have deployable spikes for penetration of the earth surface creating additional stability and security.

### FIELD OF THE INVENTION

This invention relates generally to a trailer-mounted, removable portable surface anchor able to be transported to various geographical areas, placed on the surface and able to provide support for vertically elevated objects.

### BACKGROUND OF THE INVENTION

There exist many means of stabilizing elevated structures. In the petroleum industry, the earth anchor is one of the most common. Earth anchors are often used for anchoring derricks, which can often reach up to approximately one hundred feet in height. Earth anchors come in a variety of types, including: expandable wing anchors; helical (helix) anchors; flat plate anchors; and, T-bar anchors. All of these types of anchors require excavation for installation in the earth. Typically, the derrick position is chosen in light of many factors, including: local geographical features; field equipment; and, underground structures. These same considerations as well as manufacturers' engineering specifications and governmental regulations, also mandate where derrick-supporting anchors are to be placed. Underground structures include cables, lines, conduit and piping for utilities, such as gas, electricity and water.

Frequently underground structures are compromised during excavation, which is required for placement of an earth anchor. The results can be devastating, including property damage, loss of product, environmental harm, personal injury and loss of life. Over the years, safety regulations have increased in response to injuries and death caused by excavation that compromises underground structures. Restrictions on excavation location and depth have become ever more stringent in order to avoid the above-mentioned damages.

Natural variations in local terrain, climate and geography limit placement of earth anchors. Rocks, unstable soil, previously excavated soil, and shallow ground water levels often make excavation impractical, if not impossible, in the fewer and fewer sites where excavation is allowed.

In addition to the regulatory and geographical limitation, excavation also faces constraints regarding surface and mineral interests. Rights-of-way, pits, roads, fences, and equipment limit excavation possibilities for placement of earth anchors. An example of both underground and surface limitations is a multiple well pad site. With more than one well per location, there are often separate underground utilities, property interests for both the surface and mineral estates, and multiple company ownership of structures and equipment. All the competing interests found in a multiple well pad site often impede and severely curtail excavation, thereby limiting earth anchor preparation for placement.

Vertically elevated structures require support. Earth anchors have become too cumbersome to meet safely and effectively the needs in the field. Thus, there is a long-felt need for alternatives to earth anchors.

### SUMMARY OF THE INVENTION

Accordingly, it is an object of embodiments of the present invention to provide a portable removable trailer anchor system for deployment on a ground surface for the stabilization of vertically elevated objects.

Additional objects, advantages and novel features of the invention will be set forth in part in the description which follows, and in at will become apparent to those skilled in the art upon examination of the following or may be learned by practice of the invention. The objects and advantages of the invention may be realized and attained by means of the instrumentalities and combinations particularly pointed out in the appended claims.

To achieve the foregoing and other objects, and in accordance with the purposes of the present invention, as embodied and broadly described herein, the portable removable trailer anchor system for deployment on a ground surface comprising: a trailer, at least one deployable tooth spike attached to the trailer, an anchor weight, and a means to attach the anchor weight to the trailer. In another embodiment, the present invention also includes a portable removable trailer anchor system comprising a trailer, an anchor weight, a means to attach the anchor to the trailer and at least one deployable tooth spike attached to the anchor.

The portable removable trailer anchor system is transported via its trailer to site location. The trailer, with the removable anchor attached, has at least one deployable spike to penetrate the ground surface and support elevated objects. Thus, the anchor can be used for short term purposes by deploying the at least one spike of the trailer portion and keeping the anchor attached. Alternatively, the trailer and anchor can be separated, whereby the anchor, having at least one deployable spike, can be placed on the ground surface to secure elevated objects separately from the trailer.

Benefits and advantages of the present invention include, but are not limited to, providing an apparatus stabilizing elevated objects, which is portable and can function in a variety of terrains, and accommodate a wide variety of ground surfaces, including frozen tundra.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates perspective side back view of one embodiment of the present invention.

FIG. 2 illustrates a bottom perspective view of the deployable spiked tooth assembly partially shown in FIG. I. Here the crank handle of the deployable tooth is shown and the deployable tooth is retracted.

FIG. 3 illustrates a bottom perspective view of the deployable tooth shown in FIG. 2 with the spiked deployable tooth extended.

FIG. 4 illustrates a perspective side top front blown up view of one embodiment of the 12. present invention depicting a means of attachment of the anchor to the trailer.

FIG. 5 illustrates a perspective side bottom view the anchor portion of one embodiment of the present invention with spikes extended.

FIG. 6 illustrates a perspective top side view of a spike assembly with the spike retracted from the bottom of the assembly.

FIG. 7 illustrates a perspective top side view of a spike assembly with the spike extended from the bottom of the assembly.

### DETAILED DESCRIPTION OF THE INVENTION

Reference will now be made in detail to embodiments of the invention, examples of which are illustrated in the accompanying drawings. Throughout the following detailed description, the same reference characters refer to the same or similar elements in all figures.

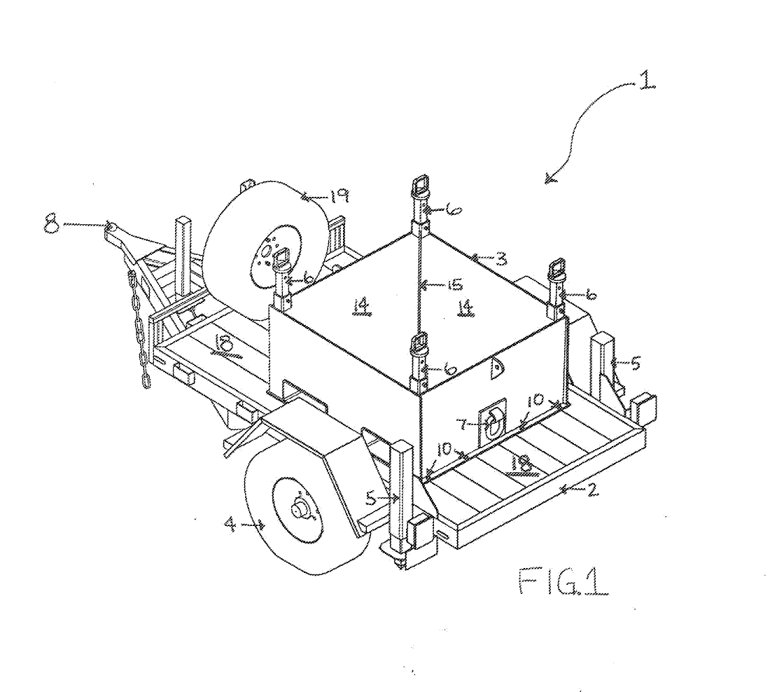

FIG. 1 depicts the portable removable trailer anchor system 1 from a back side top perspective view. The trailer 2 has at least two wheels, one wheel 4 is shown from this angle. Although not depicted there is an axle attached to the trailer 2 and the two wheels. The anchor weight 3 its on the trailer bed 18 of the trailer 2, in one embodiment of the present invention, at least one deployable tooth assembly is attached to the trailer. In FIG. 1, there are two deployable tooth assemblies 5 attached to the trailer 2. The deployable tooth crank is not depicted in the deployable tooth assembly shown in FIG. 1. In anchor trailer use, the deployable tooth extends down into the surface of the ground and the anchor becomes more immovable as the tooth spike penetrates the ground surface.

In alternative embodiments of the instant invention, the deployable tooth assemblies are attached to the anchor weight 3 on the trailer 2, in these embodiments, it is necessary that the trailer bed 18 has holes to accommodate the deployable tooth as it descends from the trailer into the ground surface below the trailer, In one embodiment of the instant invention, the anchor assembly may be located on the inside portion of the anchor or the outside portion of the anchor,

FIG. 1 also depicts four deployable spike assemblies 6 attached to the anchor weight 3 on the inside portion. In other embodiments, the attachment of the deployable spike assembly is made on the outside of the anchor. In the embodiment of the instant invention depicted in FIG. 1, the deployable spike assembly is fully retracted, as would be necessary during transportation.

FIG. 1 also depicts anchor attachment holes 10, which provide a means for attaching the anchor weight 3 to the trailer 2. Although not depicted in FIG. 1, it is understood that the attachment would be made to maximize stability and attach to the support frame of the trailer in order to secure the anchor to the trailer during use. The trailer also has a trailer hitch 8 to facilitate transport. A spare wheel 19 is also shown.

In FIG. 1, the anchor weight 3 comprises weight 14. In some embodiments of the instant invention, the anchor weight material is not separated. However as shown in FIG. 1, the anchor weight material 14 is separated by a divider 15. The anchor weight 3 has a D ring 7 attached to its bottom portion.

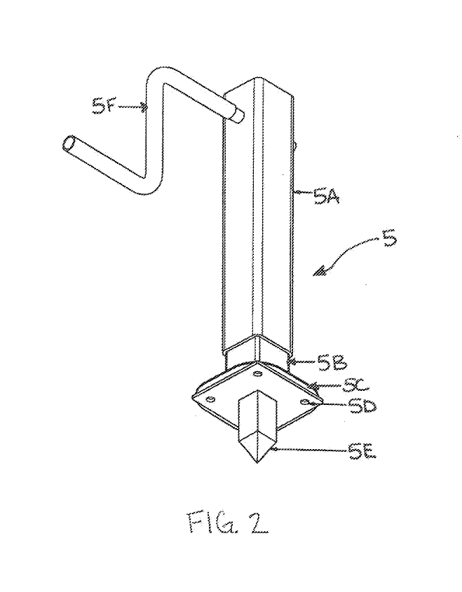

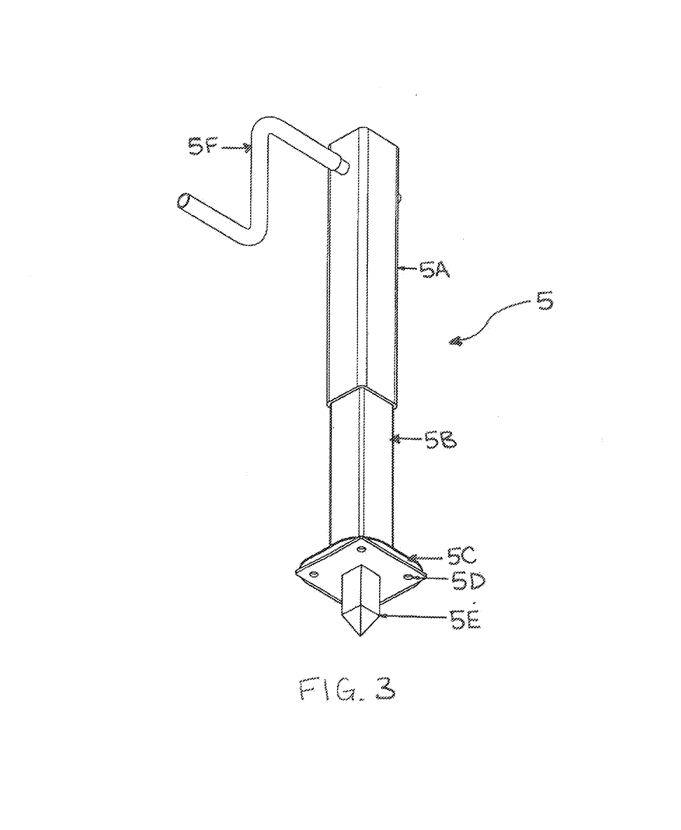

FIG. 2 show one embodiment of the tooth guide assembly 5 previously depicted in FIG. 1 wherein the tooth guide is retracted. In FIG. 2, the tooth guide assembly comprises a tooth guide 5A, which surrounds a portion of the tooth shaft 5B when retracted. The tooth guide assembly 5 extends and retracts the tooth shaft SB through operation of the tooth crank SF. The bottom of the tooth shaft 5 is attached to a tooth landing pad 5C. the tooth landing pad SC is attached to a tooth plate 5D, which is attached to the tooth spike SE which is pointed for ground penetration and securing the anchor to the ground. FIG. 3 shows an extended tooth guide. In many applications of the present invention, the tooth spike 5E extends approximately 6 inches to 12 inches below the tooth plate. The 6 inches to 12 inches of penetration into the ground is sufficient for many field applications because such lengths avoid buried underground cables and pipes found in field applications.

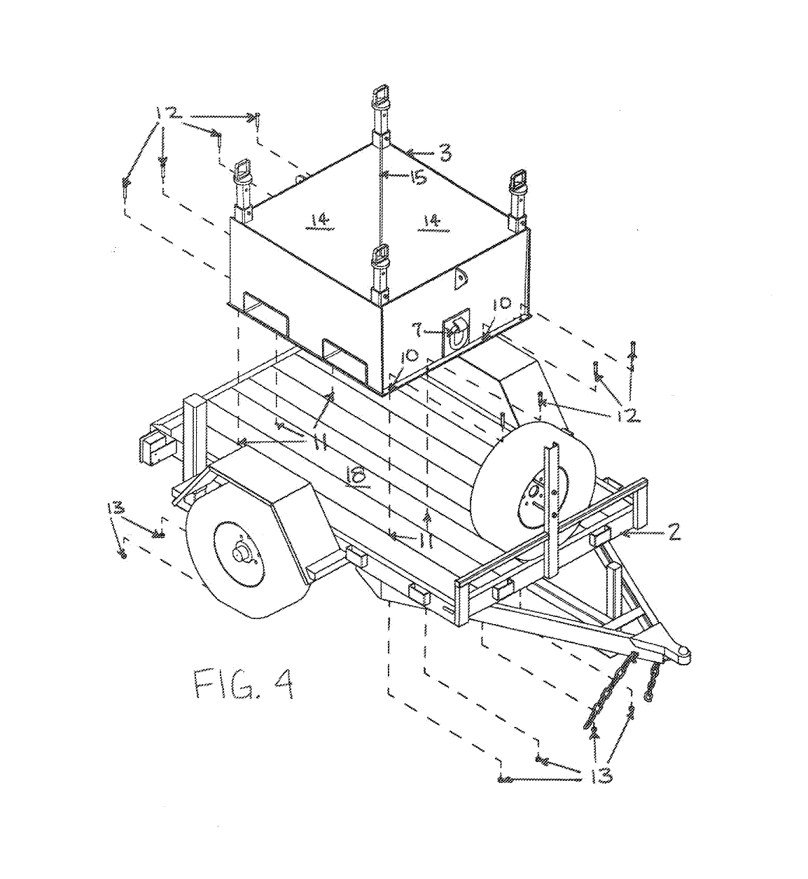

FIG. 4 shows an exploded front top side perspective view of one embodiment of the instant invention and is provided to highlight the attachment of the anchor weight 3 to the trailer 2. As depicted anchor attachment bolts 12 penetrate anchor attachment holes 10 and anchor trailer holes 11. The anchor attachment bolts secure the anchor weight 3 to the trailer 2 in this depicted embodiment. As discussed previously and not depicted here, in some embodiments of the present invention there is a hole in the trailer to provide a means for a tooth to penetrate the plane of the trailer bed 18 and extend into the surface ground beneath the trailer. Other means of attachment are fully contemplated within the context of this invention, including straps, welding and other forms of attachment as known in the attachment arts.

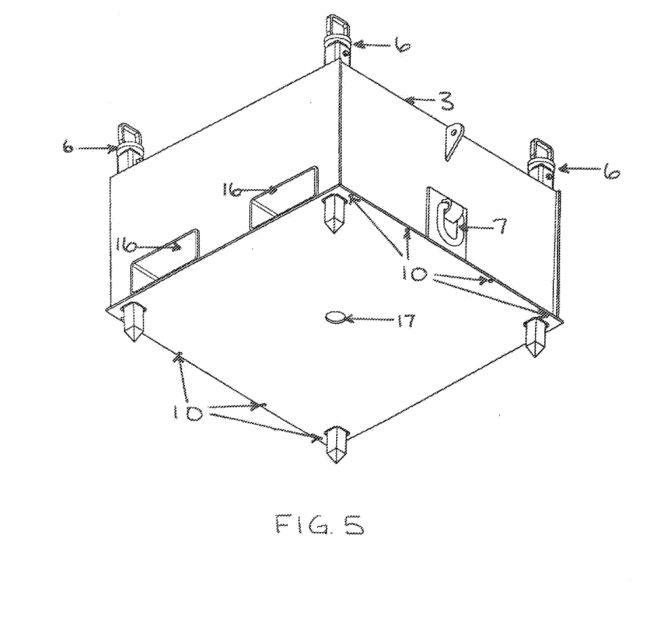

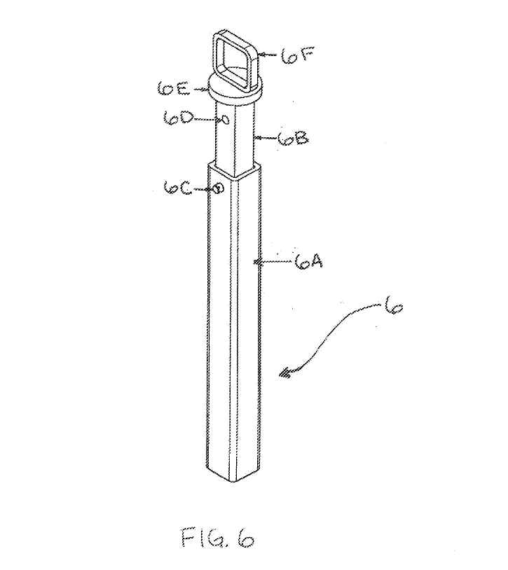

FIG. 6 depicts one embodiment of an anchor weight 3 of the present invention as separated from the trailer. The anchor weight 3 has a D ring attachment on the bottom portion in this embodiment. The bottom of the anchor weight 3 also has a centrally located hole 17 to accommodate drainage of water. The drainage of water is necessary in the field to prevent rust erosion of the anchor weight 3. FIG. 5 also depicts lift holes 16 to accommodate various lifting techniques such as slings and fork lift tines. The anchor attachment holes 10 are also depicted for accommodating anchor attachment bolts not depicted. FIG. 5 also depicts the spike tooth assembly 6.

FIG. 5 depicts a fully retracted deployable spike assembly 6. The deployable spike handle 6 is atop and attached to the deployable spike cuff 6E, which is attached to the deployable spike shaft 6B. In FIG. 6 the deployable spike shaft 6B is encased in the deployable spike guide 6A. FIG. 6 depicts a deployable spike assembly 6 wherein the deployable spike guide 6B has a deployable spike pin 6C which penetrates a deployable spike shaft pin hole (not depicted) to lock the deployable spike shaft 6B in the frilly retracted configuration. When fully retracted, as shown in FIG. 6, the deployable spike shaft pin hole 6D is shown.

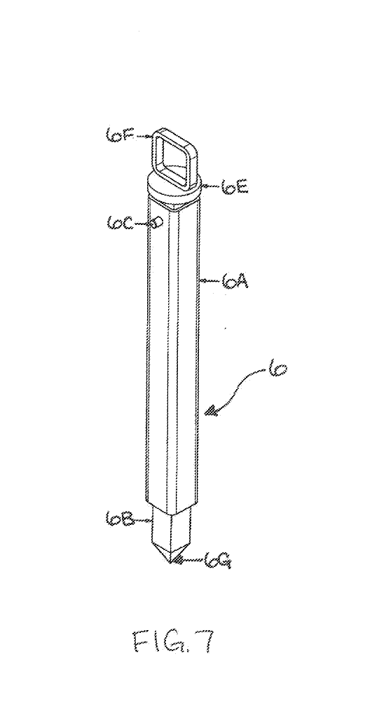

FIG. 7 shows the deployable spike assembly 6 in the fully extended deployable spike shaft 613 configuration having the deployable spike shaft point 6G shown. The deployable spike pin 6C has penetrated the deployable spike shaft pin hole 6D to lock the deployable spike shaft 6B in the fully extended configuration.

It is believed that the apparatus of the present invention and many of its attendant advantages will be understood from the foregoing description. It is also believed that it will be apparent that various changes may be made in the form, construction, and arrangement of the components without departing from the scope and spirit of the invention and without sacrificing its material advantages. The forms described are merely exemplary and explanatory embodiments thereof. It is the intention of the following claims to encompass and include such changes.

What is claimed is:

1. A portable removable trailer anchor system for deployment on a ground surface comprising: a trailer, at least one deployable tooth spike attached to the trailer, an anchor weight, and a means to attach the anchor weight to the trailer.

2. The portable removable trailer anchor system of claim 1, wherein the means to attach the anchor weight to the trailer comprises one or more bolts penetrating one or more holes in the removable anchor weight and one or more holes in the trailer and the one or more bolts secured by one or more nuts.

3. The portable removable trailer anchor system of claim 1, wherein the anchor weight comprises at least one deployable spike.

4. The portable removable trailer anchor system of claim 3, wherein the trailer comprises a hole of sufficient perimeter to permit the deployable spike to penetrate the ground surface.

5. The portable removable trailer anchor system of claim 1, wherein the at least one deployable tooth attached to the trailer is comprised of landing gear having a bottom plate and a spike attached to the bottom plate of the landing gear.

6. The portable removable trailer anchor system of claim 1, wherein the trailer comprises at least one axle attached to the trailer and at least two wheels attached to the at least one axle.

7. The removable portable surface anchor of claim 1, wherein the anchor weight has a volume of weight material.

8. The removable portable surface anchor of claim 7, wherein the anchor weight further comprises a divider to separate the volume of the anchor weight material.

9. The removable portable surface anchor of claim 1, wherein the anchor weight has a drainage bole.

10. The removable portable surface anchor of claim 1, Wherein the anchor weight further comprises a D-ring.

11. The removable portable surface anchor of claim 1, wherein the anchor weight further comprises lift tubes.

12. The removable portable surface anchor of claim 1, wherein the trailer comprises a trailer bed.

13. The removable portable surface anchor of claim 1, wherein the trailer comprises a trailer hitch.

14. A portable removable trailer anchor system comprising a trailer, an anchor weight, a means to attach the anchor weight to the trailer and at least one deployable spiked tooth attached to the anchor weight.

15. The portable removable trailer anchor system of claim 14, wherein the trailer comprises a hole of sufficient perimeter to permit the at least one deployable tooth spike attached to the anchor to descend below the trailer and penetrate the ground surface.

16. The portable removable trailer anchor system of claim 14, wherein the at least one deployable tooth attached to the anchor is comprised of landing gear having a bottom plate and a spike attached to the bottom plate of the landing gear.
